(19) United States
(12) Patent Application Publication
(10) Pub. No.: US 2007/0272217 A1
(43) Pub. Date: Nov. 29, 2007

(54) Fuel Supply Device

(75) Inventors: Kazuya Kubota, Higashimatsuyama-shi (JP); Nobuo Aoki, Higashimatsuyama-shi (JP)

Correspondence Address: CONNOLLY BOVE LODGE & HUTZ LLP, 1875 EYE STREET, N.W., SUITE 1100, WASHINGTON, DC, 20036, US

(73) Assignee: Bosch Corporation, Tok,yo (JP)

(21) Appl. No.: 10/588,446

(22) PCT Filed: Feb. 3, 2005
(86) PCT No.: PCT/JP05/01983

§ 371 Date: Apr. 6, 2007

(30) Foreign Application Priority Data
Feb. 6, 2004 (JP) 2004-30127

(51) Int. Cl. F02M 69/54; F02M 37/04

(52) U.S. Cl. 123/495

(57) ABSTRACT

In a fuel supply system (1), a fuel pressure regulating valve (11) disposed at a fuel outlet side of a low-pressure pump (3) in order to regulate the pressure of supply fuel from the low-pressure pump (3) to a predetermined pressure is housed inside a cylinder (31) such that a piston (32) is elastically urged by an elastic urging mechanism (33) toward a pressure receiving port (11A), the piston (32) is configured such that the pressure of the fuel at the fuel outlet side is regulated as a result of the piston opening/closing an overflow port (11B) disposed in a side wall portion of the cylinder (31) in response to the fuel pressure applied to the pressure receiving port (11A), a lubrication fuel outlet port (11C) for taking out fuel for lubrication is disposed in the side wall portion of the cylinder (31) at a position nearer to the pressure receiving port (11A) than the overflow port (11B), and lubricating-use fuel is taken out prior to the start of the pressure regulating operation.

### TECHNICAL FIELD

The present invention relates to a fuel supply system for supplying fuel to an internal combustion engine.

### BACKGROUND ART

Common rail type fuel supply systems have come to be utilized in recent years as fuel supply systems for supplying fuel to internal combustion engines. Common rail type fuel supply systems are configured to suck up fuel inside a fuel tank with a low-pressure fuel pump such as a feed pump, raise the pressure of the fuel with a high-pressure fuel pump, accumulate the high-pressure fuel inside a common rail, and inject/supply the high-pressure fuel inside the common rail to the inside of the cylinders of an internal combustion engine using a fuel injection valve.

A drive shaft of the high-pressure fuel pump used for this purpose is driven by the large power of the internal combustion engine, whereby the pressure of the fuel is raised. In order to ensure the smooth operation of the high-pressure fuel pump, JP-A-2002-322968 discloses a low-pressure fuel pump disposed with a fuel chamber pressure regulating valve including a pathway that takes in fuel to be used for lubricating fuel for actuating the high-pressure system fuel pump. According to this disclosed configuration, the fuel chamber pressure regulating valve works as a pressure regulating valve for maintaining the pressure in the fuel chamber at an appropriate value and is configured such that fuel is not supplied to the lubricating fuel line until the pressure in the fuel chamber reaches a pressure sufficient for injection during startup; thus, excellent startability can be ensured.

However, according to this disclosed fuel supply system, back pressure arises in the fuel chamber pressure regulating piston when the pressure of the lubricating fuel line rises due to whatever reason; thus, there is the problem that the movement of the piston is hindered, the operation of regulating the pressure of the fuel cannot be conducted as intended, and the pressure of the fuel supplied to the high-pressure fuel pump becomes excessively large.

It is an object of the present invention to provide a fuel supply system that can solve the aforementioned problem in the prior art.

It is another object of the present invention to provide a fuel supply system configured such that it can conduct without hindrance the operation of regulating the pressure of the fuel even if back pressure arises in the lubricating fuel line.

### DISCLOSURE OF THE INVENTION

The present invention is characterized in that a lubricating fuel line is disposed at a pressure receiving side of a piston of a fuel pressure regulating valve, whereby the fuel pressure regulating operation of the piston is not hindered even if pressure arises in the lubricating fuel line. In order to balance the selection of spring specifications satisfying the pressure regulating characteristics and high piston stroke necessary in the fuel pressure regulating valve, two types of springs are serially disposed to impart a two-stage piston stroke characteristic, whereby it can be ensured that the operation of the piston for regulating the fuel pressure is not hindered by pressure arising in the lubricating fuel line.

The present invention provides a fuel supply system comprising a pump for raising the pressure of and supplying supply fuel and a fuel pressure regulating valve disposed at a fuel outlet side of the pump in order to regulate the pressure of the fuel supplied from the pump to a predetermined pressure, wherein the fuel pressure regulating valve includes a cylinder in which a piston is housed, the piston is elastically urged by an elastic urging mechanism toward a pressure receiving port, the piston is configured such that the pressure of the fuel at the fuel outlet side is regulated as a result of the piston opening/closing an overflow port disposed in a side wall portion of the cylinder in response to the fuel pressure at the fuel outlet side applied to the pressure receiving port, and a lubrication fuel outlet port for taking out fuel for lubrication is disposed in the side wall portion of the cylinder at a position nearer to the pressure receiving port than the overflow port.

According to the present invention, fuel for lubrication can be taken out without hindering the operation of regulating the pressure of the fuel supplied from the pump.

### BRIEF DESCRIPTION OF THE DRAWINGS

FIG. 1 is a configural diagram showing an embodiment of a fuel supply system according to the present invention.

FIG. 2 is an enlarged cross-sectional diagram of a fuel pressure regulating valve shown in FIG. 1.

FIG. 3 is a graph showing the relationship between fuel pressure and the lift of a piston in the fuel pressure regulating valve of FIG. 2.

FIG. 4 is a graph showing the relationship between fuel pressure and the flow rate of fuel at each port in the fuel pressure regulating valve of FIG. 2.

FIG. 5 is a cross-sectional diagram showing a modification of the fuel pressure regulating valve shown in FIG. 2.

### BEST MODE FOR IMPLEMENTING THE INVENTION

The present invention will now be described in greater detail in accordance with the attached drawings.

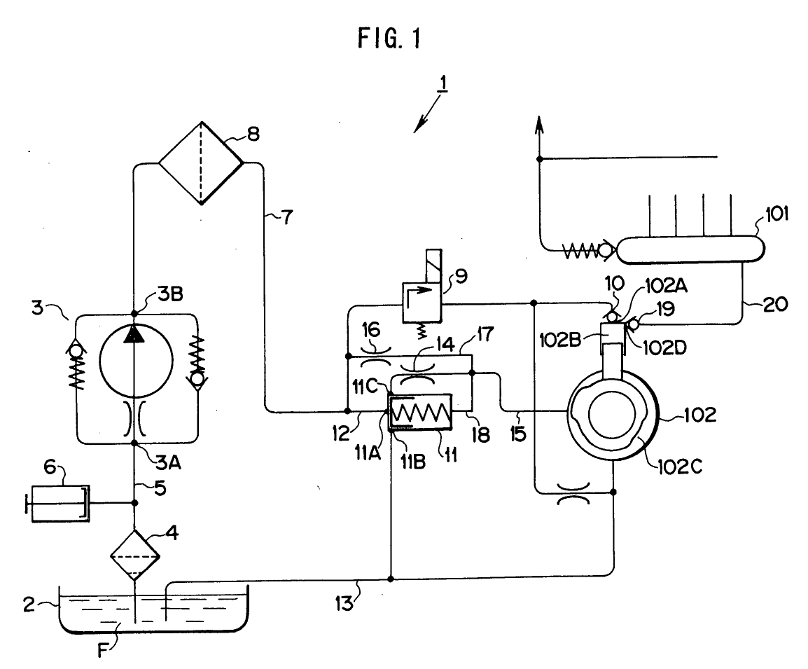

FIG. 1 is a configural diagram showing an embodiment of a fuel supply system according to the present invention. A fuel supply system 1 is a system for supplying relatively low-pressure fuel to a high-pressure pump 102 that supplies high-pressure fuel to a common rail 101. The fuel supply system 1 is disposed with a fuel tank 2 and a low-pressure pump 3 that raises the pressure of fuel F inside the fuel tank 2.

A fuel supply path 5 disposed with a filter 4 is disposed between a fuel inlet port 3A of the low-pressure pump 3 and the fuel tank 2. The fuel supply path 5 is configured such that fuel from which debris and the like has removed by the filter 4 is sent from the fuel tank 2 to the low-pressure pump 3 through the fuel supply path 5. That which is represented by reference numeral 6 is a manual pump that is used to manually feed the fuel into the low-pressure pump 3 when air has entered the low-pressure system line as a result of replacing the filter or the like.

A fuel supply path 7 for supplying, to the high-pressure pump 102, the low-pressure fuel supplied from the low-pressure pump 3 is disposed between an outlet port 3B that is a fuel outlet of the low-pressure pump 3 and an intake port 102A of the high-pressure pump 102. A filter 8, for removing debris and the like in the fuel sent from the low-pressure pump 3, and a control valve 9, which is configured using a proportional electromagnetic valve in order to control the flow rate of the low-pressure fuel supplied to the high-pressure pump 102, are disposed in the fuel supply path 7. The low-pressure fuel whose flow rate is controlled by the control valve 9 is supplied via a check valve 10 from the intake port 102A of the high-pressure pump 102 to the inside of a cylinder chamber 102B of the high-pressure pump 102. The control valve 9 controls the flow rate as a result of being electrically controlled by an unillustrated electrical control unit. As a result, the rail pressure inside the common rail 101 is controlled to become a given target rail pressure.

A fuel pressure regulating valve 11 is connected to the fuel supply path 7 for the purpose of maintaining the pressure of the low-pressure fuel at the fuel inlet side of the control valve 9 at a predetermined value. In the fuel supply system 1 shown in FIG. 1, a pressure receiving port 11A of the fuel pressure regulating valve 11 is connected by a pipe 12 to the fuel supply path 7 between the filter 8 and the control valve 9. The fuel pressure regulating valve 11 is configured to operate such that it maintains the pressure of the low-pressure fuel at the inlet side of the control valve 9 at a substantially predetermined constant pressure by causing the low-pressure fuel to overflow from an overflow port 11B of the fuel pressure regulating valve 11 when the pressure of the low-pressure fuel at the pressure receiving port 11A exceeds a predetermined level. The overflow low-pressure fuel from the overflow port 11B is returned to the inside of the fuel tank 2 through a drain pipe 13.

The fuel pressure regulating valve 11 further includes a lubrication fuel outlet port 11C for taking out, as lubricating fuel, the fuel sent from the low-pressure pump 3. The fuel taken out from the lubrication fuel outlet port 11C is sent to the inside of a cam chamber 102C of the high-pressure pump 102 through a lubricating fuel line 15 disposed with an orifice 14, so that the fuel works as lubricating fuel. It will be noted that the fuel sent to the high-pressure pump 102 via the lubricating fuel line 15 is not limited to being used as lubricating fuel for the respective members inside the cam chamber 102C. Of course, the fuel may also be appropriately supplied as lubricating fuel for other sites.

As described above, the low-pressure fuel whose pressure has been regulated to a predetermined pressure and whose flow rate has been regulated by the fuel supply system 1 is sent to the high-pressure pump 102. Then, the pressure of the low-pressure fuel is raised inside the cylinder chamber 102B of the high-pressure pump 102, and the resulting high-pressure fuel is sent from a discharge port 102D of the high-pressure pump 102 to the common rail 101 via a check valve 19 and a high-pressure pipe 20.

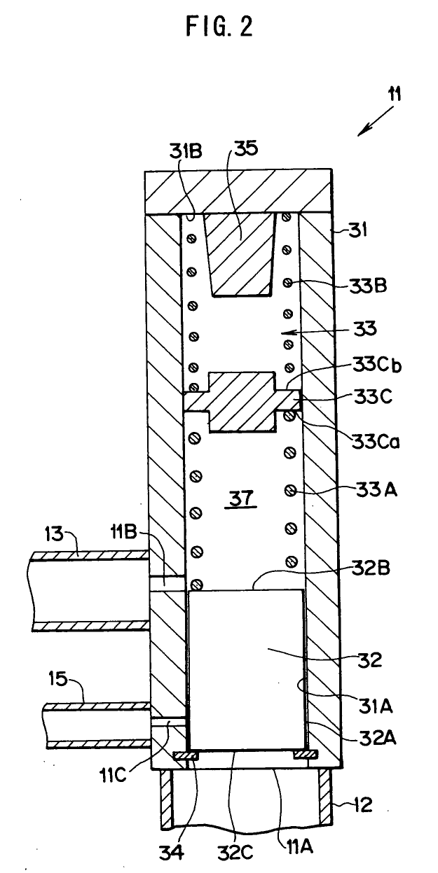

FIG. 2 is an enlarged cross-sectional diagram of the fuel pressure regulating valve 11 shown in FIG. 1. The fuel pressure regulating valve 11 includes a cylinder 31, and a piston 32 is housed inside the cylinder 31 such that the piston 32 can freely slide inside the cylinder 31. An open portion in one end of the cylinder 31 serves as the pressure receiving port 11A, and the pressure receiving port 11A is connected to the fuel supply path 7 via the pipe 12 (see FIG. 1). The piston 32 is a solid circular columnar member, and the space between an outer peripheral surface 32A of the piston 32 and an inner peripheral surface 31A of the cylinder 31 is fuel-tight. An elastic urging mechanism 33 for elastically urging the piston 32 toward the pressure receiving port 11A is disposed in a chamber 37 defined by the cylinder 31 and the piston 32.

The elastic urging mechanism 33 has a configuration where a first spring 33A with a spring constant K1 and a second spring 33B with a spring constant K2 (<K1) are serially disposed. Here, coil springs are used for both the first spring 33A and the second spring 33B, and a spring seat 33C is disposed between the first spring 33A and the second spring 33B.

The first spring 33A is disposed between an inner end surface 32B of the piston 32 and one end surface 33Ca of the spring seat 33C, and elastically urges the spring seat 33C away from the inner end surface 32B. The second spring 33B is disposed between an inner end surface 31B of the cylinder 31 and another end surface 33Cb of the spring seat 33C, and elastically urges the spring seat 33C away from the inner end surface 31B.

As a result, the piston 32 is elastically urged by the first spring 33A and the second spring 33B toward the pressure receiving port 11A. A stopper ring 34 is disposed in the vicinity of the pressure receiving port 11A, and when the fuel pressure applied to the pressure receiving port 11A is equal to or less than a predetermined value, a pressure receiving surface 32C of the piston 32 comes into contact with the stopper ring 34 so that the piston 32 is positioned in the position shown in FIG. 2.

Because the elastic urging mechanism 33 is configured as described above, the piston 32 is positioned at a position where the fuel pressure acting on its pressure receiving surface 32C and the spring force resulting from the first spring 33A and the second spring 33B of the elastic urging mechanism 33 are balanced. Because the spring constant K2 is less than the spring constant K1, primarily the second spring 33B is first compressed as the fuel pressure increases, the spring seat 33C comes into contact with a stopper 35 disposed on the inner end surface 31B, and thereafter the first spring 33A is compressed.

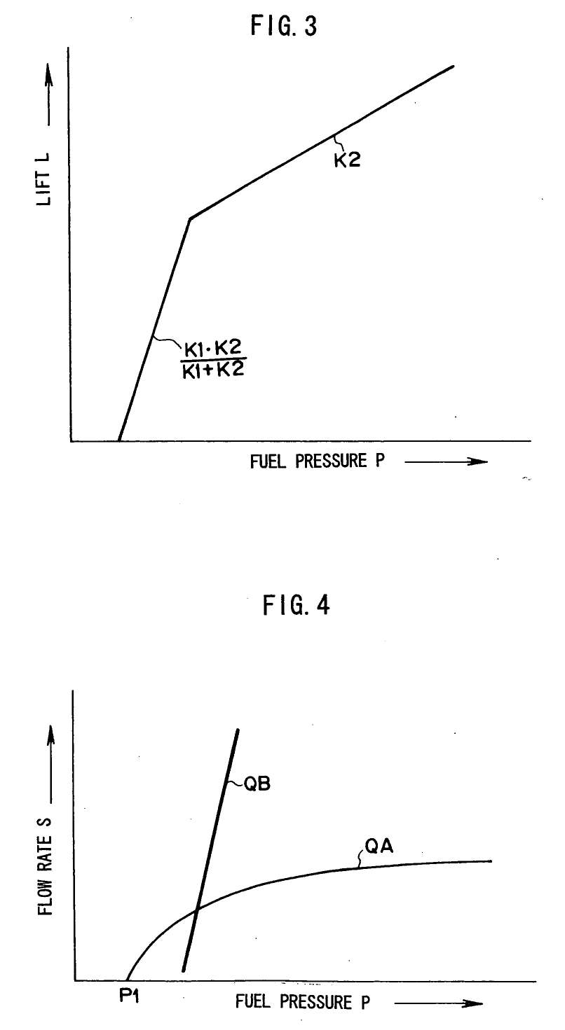

Consequently, assuming that P represents the fuel pressure in the pressure receiving port 11A and L represents the lift of the piston 32 from the piston shown in FIG. 2, the relationship between the two is as shown in FIG. 3. Until the spring seat 33C comes into contact with the stopper 35, the piston 32 moves in accordance with the characteristic line (a) of the composite spring constant K1×K2/(K1+K2), and after the spring seat 33C comes into contact with the stopper 35, the piston 32 moves in accordance with the characteristic line (b) of the spring constant K2.

Two ports are disposed in a side wall portion of the cylinder 31 because the regulation of the fuel pressure at the fuel inlet side of the control valve 9 and the taking-out of the fuel used as lubricating fuel are conducted utilizing the fact that the piston 32 is positioned inside the cylinder 31 in response to the fuel pressure applied to the pressure receiving port 11A. One of these two ports is the overflow port (first port) 11B for causing the fuel to overflow in order to regulate the fuel pressure, and the other of these two ports is the lubrication fuel outlet port (second port) 11C for taking out a small amount of fuel to the lubricating fuel line 15 when the fuel pressure reaches a predetermined level.

The overflow port 11B is disposed at a position where it can allow the pipe 12 to be communicated with the drain pipe 13 when the fuel pressure at the pressure receiving port 11A reaches a target value where required pressure regulation is to be conducted. The lubrication fuel outlet port 11C is disposed nearer to the pressure receiving port 11A than the overflow port 11B, and the position of the lubrication fuel outlet port 11C is a position where the lubrication fuel outlet port 11C can allow the pipe 12 to be communicated with the lubricating fuel line 15 after the fuel pressure at the pressure receiving port 11A reaches a pressure sufficient for injection after startup.

Because the fuel pressure regulating valve 11 is configured as described above, the piston 32 moves in the direction of the elastic urging mechanism 33 as a result of the fuel pressure in the pressure receiving port 11A rising after startup, and after the fuel pressure reaches a pressure sufficient for injection, the lubrication fuel outlet port 11C that had been blocked by the outer peripheral surface 32A of the piston 32 is opened up so that fuel begins flowing from the pipe 12 to the lubricating fuel line 15. This is the timing when P equals P1 in FIG. 4. Because the lubrication fuel outlet port 11C is formed as an orifice, even if the fuel pressure rises thereafter, the flow rate QA of the fuel passing through the lubrication fuel outlet port 11C only increases with a small inclination as shown in FIG. 4. As a result, when P is greater than P1, the amount of fuel supplied as lubricating fuel is maintained at a relatively small value.

The overflow port 11B that had been blocked by the outer peripheral surface 32A of the piston 32 is opened up as a result of the fuel pressure in the pressure receiving port 11A exceeding a predetermined value, and the fuel from the pipe 12 escapes to the drain pipe 13 so that the fuel pressure in the pressure receiving port 11A is reduced. When the fuel pressure drops in this manner, the overflow port 11B is again blocked by the outer peripheral surface 32A of the piston 32, and the fuel pressure rises. In this manner, the fuel pressure in the pressure receiving port 11A is regulated to become a predetermined level as a result of the piston 32 being positioned in response to the fuel pressure in the pressure receiving port 11A and opening/closing the overflow port 11B. It will be noted that because the fuel-tightness between the inner peripheral surface 31A and the outer peripheral surface 32A is set such that the pressure inside the chamber 32 can appropriately escape from the overflow port 11B through the gap between the inner peripheral surface 31A and the outer peripheral surface 32A, a large back pressure does not arise in the piston 32 and cause drawbacks to the pressure regulating operation thereof.

Because the fuel pressure regulating valve 11 operates as described above, the operation of the piston 32 for regulating the fuel pressure in the pressure receiving port 11A is not at all affected even if there is a rise in pressure due to whatever reason in the lubricating fuel line 15, and fuel for lubrication can be taken out without hindering the operation of regulating the pressure of the fuel supplied from the low-pressure pump 3. As a result, there are no changes in the characteristics of the fuel pressure regulating valve 11 that regulates the fuel pressure at the fuel inlet side of the control valve 9 even if back pressure acts on the lubricating fuel line 15, and stable flow rate control is realized in the control valve 9.

In the above-described embodiment, the elastic urging mechanism 33 disposed in the fuel pressure regulating valve 11 is configured using two coil springs. However, the elastic urging mechanism 33 is not limited to this configuration and may also be configured using one coil spring.

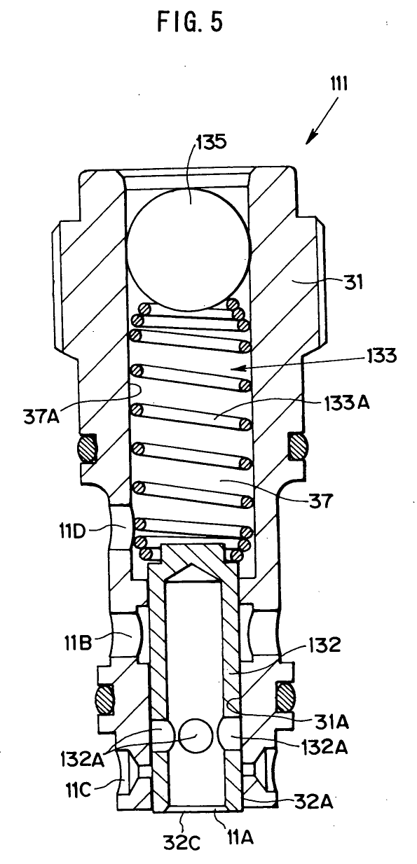

FIG. 5 shows the configuration of a fuel pressure regulating valve where the elastic urging mechanism is configured using one coil spring. This fuel pressure regulating valve 111 is different from the fuel pressure regulating valve 11 shown in FIG. 2 only in that an elastic urging mechanism 133 is configured using one coil spring 133A, and the remaining configuration of the fuel pressure regulating valve 111 is the same as that of the fuel pressure regulating valve 11. Consequently, the same reference numerals will be given to portions of the fuel pressure regulating valve 111 that correspond to portions of the fuel pressure regulating valve 11, and redundant description of those same portions will be omitted.

In the fuel pressure regulating valve 111, a piston 132 is hollow, and a pressure regulating operation is conducted where the fuel pressure inside the pipe 12 escapes from the overflow port 11B when plural through holes 132A disposed in the outer peripheral wall of the piston 132 face the overflow port 11B. Further, a fat diameter portion chamber 37A, whose diameter is fatter than the outer peripheral diameter of the piston 132 and in which an escape hole 11D is disposed, is formed in the chamber 37 of the cylinder 31, and a space is always formed between the inner peripheral wall of the fat diameter portion chamber 37A and the outer peripheral wall of the piston 132. For this reason, the pressure inside the chamber 37 can always escape to the fuel low-pressure portion via the escape hole 11D without the outer peripheral wall of the piston 132 blocking the escape hole 11D while the piston 132 is moving, and back pressure hindering the movement of the piston 132 does not act on the piston 132. That which is represented by reference numeral 135 is a ball portion for blocking one end of the cylinder 31.

### INDUSTRIAL APPLICABILITY

According to the present invention, the regulation of fuel pressure and the taking-out of lubricating fuel can be smoothly conducted, which is useful for the improvement of fuel supply systems.

1. A fuel supply system comprising a pump for raising the pressure of and supplying supply fuel and a fuel pressure regulating valve disposed at a fuel outlet side of the pump in order to regulate the pressure of the fuel supplied from the pump to a predetermined pressure, wherein the fuel pressure regulating valve includes a cylinder in which a piston is housed, the piston is elastically urged by an elastic urging mechanism toward a pressure receiving port of the cylinder, the piston is configured such that the pressure of the fuel is regulated as a result of the piston opening/closing an overflow port disposed in a side wall portion of the cylinder in response to the fuel pressure in the pressure receiving port, and a lubrication fuel outlet port for taking out fuel for lubrication is disposed in the side wall portion of the cylinder at a position nearer to the pressure receiving port than the overflow port.

2. The fuel supply system of claim 1, wherein the elastic urging mechanism comprises a single elastic urging member.

3. The fuel supply system of claim 1, wherein the elastic urging mechanism comprises plural elastic urging members that are serially disposed and have different spring constants, and is disposed with a piston stroke characteristic including different plural piston stroke characteristic portions.

4. The fuel supply system of claim 1, wherein an escape hole for allowing back pressure of the piston to escape to a fuel low-pressure side is disposed in the sidewall portion of the cylinder.

5. The fuel supply system of claim 2, wherein an escape hole for allowing back pressure of the piston to escape to a fuel low-pressure side is disposed in the sidewall portion of the cylinder.

6. The fuel supply system of claim 3, wherein an escape hole for allowing back pressure of the piston to escape to a fuel low-pressure side is disposed in the sidewall portion of the cylinder.
